(19) United States
(12) Patent Application Publication
(10) Pub. No.: US 2018/0217838 A1
(43) Pub. Date: Aug. 2, 2018

(54) ULTRA LEAN VECTOR PROCESSOR

(71) Applicant: Futurewei Technologies, Inc., Plano, TX (US)

(72) Inventors: Weizhong Chen, Frisco, TX (US); Tong Sun, Allen, TX (US); Bin Yang, Shanghai (CN)

(73) Assignee: Futurewei Technologies, Inc., Plano, TX (US)

(21) Appl. No.: 15/422,014

(22) Filed: Feb. 1, 2017

(51) Int. Cl. G06F 9/30; H04W 88/10; G06F 12/0875

(52) U.S. Cl. CPC G06F 9/30036; H04W 88/10; G06F 9/3016; G06F 9/3001; G06F 2212/452; G06F 9/3012; G06F 9/30043; G06F 12/0875; G06F 9/3005

(57) ABSTRACT

An apparatus comprises a central processor that outputs a first control signal to data organizers that organizes and moves data and a second control signal to vector processors that receives a first and second set of data from the data organizers. A first vector processor includes a first instruction circuit that executes a first plurality of vector functions and a second instruction circuit that executes a second plurality of vector functions. A first vector function is selected from the first plurality of vector functions to process the first set of data in response to the second control signal. Similarly, a second vector function is selected from the second plurality of vector functions to process the second set of data in response to the second control signal.

### BACKGROUND

Multiple radio technologies (air interfaces) may be included in a computing device that communicates with user equipment (UE) in a cellular network. The computing device may operate simultaneously and variant dynamically at a microsecond level. For example, a computing device may operate in a 20 MHz baseband and then switch quickly in microseconds to a 100 MHz or 5 MHz baseband in communicating with UEs in a cellular network.

A computing device that communicates with a UE in a cellular network may include front and back-end processing. For example, front-end processing may receive signals from an antenna via an analog-to-digital converter (ADC); while, back-end processing may include data recovery processing.

Front-end processing may also include different filtering operations to isolate signals from a received mixture of multiple radio baseband signals. After separating or isolating received signals, front-end processing may include signal processing before back-end processing typically performs more flexible data recovery processing.

### SUMMARY

In a first embodiment, the present technology relates to an apparatus comprising a central processor that outputs a first control signal to data organizers that organizes and moves first and second sets of data and a second control signal to the vector processors that receive the first and second sets of data from the data organizers. A first vector processor includes a first instruction circuit that executes a first plurality of vector functions and a second instruction circuit that executes a second plurality of vector functions. A first vector function is selected from the first plurality of vector functions to process the first set of data in response to the second control signal. Similarly, a second vector function is selected from the second plurality of vector functions to process the second set of data in response to the second control signal.

A second embodiment in accordance with the first embodiment, wherein the first plurality of vector functions include a plurality of signal processing functions that include a vector processing of the first set of data and the second plurality of functions include a fixed point vector processing function or a floating point vector processing function of the second set of data.

A third embodiment in accordance with the first through second embodiments, wherein each of the vector functions in the first plurality of vector functions processes the first set of data in over approximately a hundred clock cycles of a clock signal to obtain a result.

A fourth embodiment in accordance with the first through third embodiments, wherein the second instruction circuit uses no more than approximately five clock cycles to perform each of the vector functions in the second plurality of vector functions.

A fifth embodiment in accordance with the first through the fourth embodiments, wherein the first instruction circuit comprises a configuration circuit that outputs a configuration signal in response to the second control signal. A control logic outputs a third, fourth, fifth, sixth and seventh control signal in response to the configuration signal. An operation element array is configured in response to the third control signal and a register array stores the first set of data or a result in response to the fifth control signal. An interconnection is configured between the operation elements array and the register array in response to the fourth control signal. A load circuit writes the first set of data to the register array in response to the sixth control signal and a store circuit stores the result from the register array in response to the seventh control signal.

A sixth embodiment in accordance with the first through fifth embodiments, wherein the first vector processor comprises a first interface that receives the second set of data from the one or more data organizers. A data memory stores the second set of data from the first interface and a vector data organizer circuit receives the second set of data from the data memory. A second interface receives the second control signal and an instruction cache stores control information of the second control signal from the second interface. A processing control circuit receives the control information from the instruction cache. The processing control circuit outputs a first instruction to the first instruction circuit to select the first vector function and outputs a second instruction to the second instruction circuit to select the second vector function in response to the control information.

A seventh embodiment in accordance with the first through sixth embodiments, one or more instruction circuits are coupled to the vector processor circuit and execute a third plurality of vector functions. The third vector function is selected from the third plurality of vector functions to process the a third set of data in response to a third control signal from the vector processor.

A eighth embodiment in accordance with the first through seventh embodiments, wherein the first plurality of vector functions includes at least one of: filtering the first set of data, cancelling passive intermodulation (PIM) in the first set of data, converting the first set of data from a time domain to a frequency domain and converting the first set of data from an antenna domain to a beam domain. The second plurality of vector functions include at least one of a: floating point operation of the second set of data, fixed point operation of the second set of data, summation of the second set of data, subtraction of the second set of data, multiplication of the second set of data and division of the second set of data.

A ninth embodiment in accordance with the first through eighth embodiments, further comprises a processor control circuit to decode and execute change of flow (COF), scalar, load and store instructions.

A tenth embodiment in accordance with the first embodiment, wherein the apparatus is included in a base station having an antenna to receive a 5G signal from a user equipment in a cellular network. The first and second sets of data are obtained from the 5G signal.

In another embodiment, an integrated circuit processes a set of data received from an antenna in a cellular network. The integrated circuit comprises a data memory to store a set of data. A data organization circuit organizes the set of data from the data memory and a first instruction circuit executes a first vector processing function on the set of data from the data organization circuit from a first plurality of vector functions. A second instruction circuit executes a second vector processing function on the set of data from the data organization circuit from a second plurality of vector functions. An instruction cache stores control information represented by a first control signal. A processor control circuit receives the control information from the instruction cache and outputs a second control signal to the first instruction circuit to select the first vector processing function in response to receipt of the control information from the instruction cache. The processor control circuit outputs a third control signal to the second instruction circuit to select the second vector processing function in response to receipt of the control information from the instruction cache. The first plurality of functions is different than the second plurality of functions.

In another embodiment, the present technology relates to a method of operating a vector processor. The method performs the steps of receiving a control signal that indicates a first and second vector function are to be performed by the vector processor. A vector instruction circuit in the vector processor is configured to perform the first vector function in response to the control signal. A big instruction circuit in the vector processor is configured to perform the second vector function in response to the control signal. A first set of data is organized to be processed by a data organization circuit in the vector instruction circuit. A second set of data is organized to be processed by the data organization circuit in the big instruction circuit. The first vector function is performed on the first set of data by the vector instruction circuit to provide a first result and the second vector function is performed on the second set of data by the big instruction circuit to provide a second result. The first and second results are output from the vector processor.

This Summary is provided to introduce a selection of concepts in a simplified form that are further described below in the Detailed Description. This Summary and/or headings are not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a block diagram of an ultra-lean vector processor unit (UL VPU) system according to embodiments of the present technology.

FIG. 2 is a block diagram of a UL VPU system having extended big instruction units (eBIUs) according to embodiments of the present technology.

FIG. 3 is a block diagram of UL VPU architecture according to embodiments of the present technology.

FIG. 4 is a block diagram of a big instruction unit (BIU) architecture according to embodiments of the present technology.

FIG. 5 is a block diagram of data organization system according to embodiments of the present technology.

FIG. 6 is a flowchart that illustrates a method of operating a UL VPU according to embodiments of the present technology.

FIG. 7 is a flowchart that illustrates a method of operating a BIU according to embodiments of the present technology.

FIG. 8 is a flowchart that illustrates a method of operating a data organization system according to embodiments of the present technology.

FIG. 9 is a block diagram that illustrates a hardware architecture according to embodiments of the present technology.

FIG. 10 illustrates a cellular network having multiple cells according to embodiments of the present technology.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The present technology generally relates to an ultra lean vector processor that enables front end processing in early stages of 5th generation wireless systems (5G) technology as well as vector intensive processing that may occur at the mature stages of the 5G technology.

In embodiments, a vector processor includes two instruction units: a big instruction unit to perform complex vector processing calculations, such as signal processing calculations, and a vector instruction unit to perform less complex vector processing calculations, such as arithmetic functions. In an embodiment, an ultra lean vector processor is able to perform a large vector calculation of large amounts of data that may be required in the signal processing for multi-input and multi-output (MIMO) antennas and/or an ultra-wide bands in mature stages of 5G technology. Although large vector calculations may be more power efficient, large vector calculations may not be appropriate for other functions; and thus may be overused.

While the ultra lean vector processor may perform intensive, real-time and highly structural vector processing, the ultra lean vector processor's architecture enables different types of vector processing functions to be performed by different programmable circuits. A vector instruction unit (or circuit) performs relatively simple vector processing, such as floating point arithmetic using a relatively small instruction set; while a big instruction unit (or circuit) performs more complex vector processing functions, such as converting signals in the time domain to the frequency domain, that may take the big instruction unit over approximately 100 clock cycles to perform.

In various embodiments, enhanced big instruction units to perform complex vector processing may also be added to the ultra lean vector processor when large vector calculations may be needed in the mature stages of 5G technology.

In various embodiments, a data organization system, including an upper and lower data organization units (or data organizers) along with an instruction level data organization unit move and organize data sets in parallel so that cores of a vector instruction unit and/or big instruction unit may efficiently focus on vector calculations on the received data sets rather than preparing the data for vector calculations.

It is understood that the present technology may be embodied in many different forms and should not be construed as being limited to the embodiments set forth herein. Rather, these embodiments are provided so that this disclosure will be thoroughly and completely understood. Indeed, the disclosure is intended to cover alternatives, modifications and equivalents of these embodiments, which are included within the scope and spirit of the disclosure as defined by the appended claims. Furthermore, in the following detailed description, numerous specific details are set forth in order to provide a thorough understanding of the technology. However, it will be clear that the technology may be practiced without such specific details.

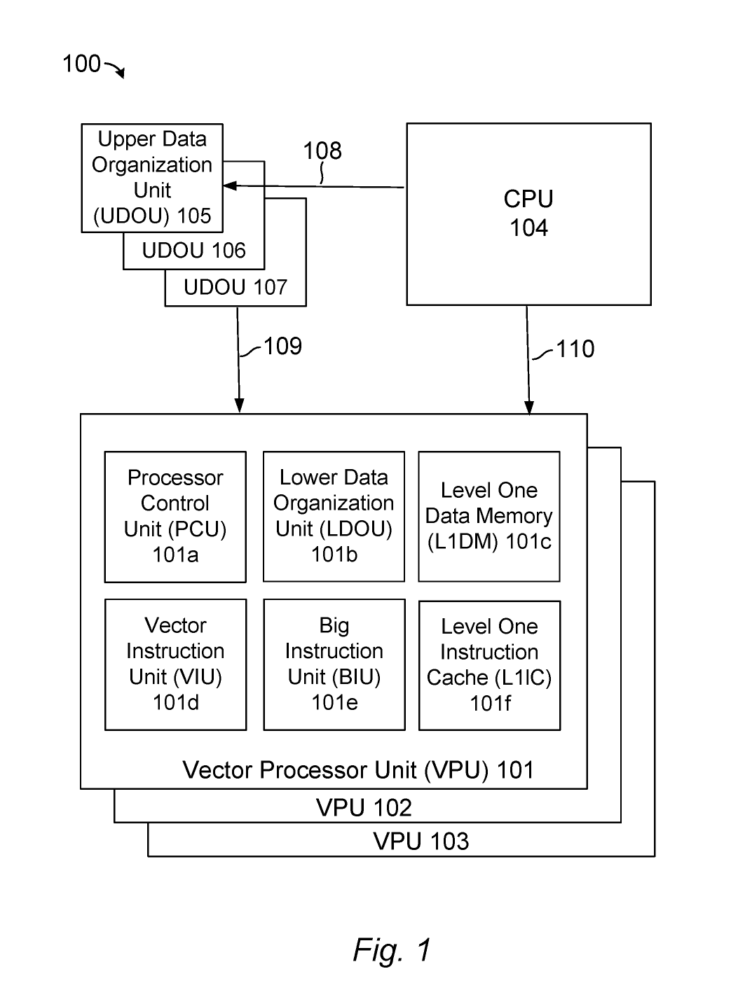

FIG. 1 is a block diagram of an ultra-lean vector processor unit (UL VPU) system 100 according to embodiments of the present technology. System 100 includes a set of vector processors (VPUs) 101-103 coupled to a central processing unit (CPU) 104 by signal path(s) 110 and a set of upper data organization units (UDOUs) 105-107 coupled to CPU 104 by signal path(s) 108. UDOUs 105-107 are coupled to VPU 101-103 via signal path(s) 109.

As one of ordinary skill in the art would appreciate, a particular description or illustration of a component or circuit herein may also correspond to similar components or integrated circuits in the set in embodiments. For example, a description of VPU 101 in VPUs 101-103 may correspond to VPUs 102 and 103 in embodiments. In other embodiments, a particular description of VPU 101 would not necessarily correspond to one or more of VPUs 102 and 103. In embodiments, a term “unit” may include a circuit (or integrated circuit) and a data organization unit may include a data organizer or data organizer circuit.

In an embodiment, a VPU 101 implements an instruction set containing instructions that operate on sets of data that include one-dimensional arrays of data called vectors. In an embodiment, a VPU 101 is an integrated circuit processor that can operate on an entire vector in one instruction. The operand to the instructions are complete vectors instead of one element in an embodiment. Vector processors may reduce the fetch and decode bandwidth as the number of instructions fetched are less in embodiments. In an embodiment, each VPU in a set of VPUs may operate in parallel.

VPU 101 (as well as VPUs 102-103) may be a VPU that includes an ultra lean program control unit, a big instruction unit (BIU) 101e and a vector instruction unit (VIU) 101d in embodiments. In an embodiment, BIU 101e executes a selected vector function from a plurality of vector functions which may take longer than approximately 100 cycles of clock signal. VIU 101d provides flexibility to cover areas that BIU 101e does not cover and fuse the functions implemented by BIU 101e to perform a particular task of a VPU. For example, VIU 101d may execute a selected vector function from a plurality of vector functions with a relatively small instruction set, such as approximately fifty instructions. For example, VIU 101d may include a plurality of vector functions that perform arithmetic vector operations while BIU 101e may include a plurality of vector functions for relatively complex vector processing, such a converting a set of data from a time domain to a frequency domain.

In embodiments, a VIU 101d in a VPU 101 may be relatively lean by offloading a number of typical functions: 1) some control functions to CPU 104, 2) complex vector functions to BIU 101e and data organization to UDOU 105 and LDOU 101b. In embodiments, a VIU 101d in VPU 101 may be a lean by using relatively small instruction set architecture (ISA) due to the offloading a majority of complex vector processing functions to BIU 101e.

In embodiments, computation tasks are executed alternately between VIU 101d/PCU 101a (instruction sequences) and BIU 101e. In an embodiment, a computation task may initiate either with VIU 101d processing or alternatively with BIU 101e processing. Resulting data generated by a VIU 101d/PCU 101a instruction sequence may then be processed by BIU 101e. Then results from BIU 101e may be processed by another VIU 101d and PCU 101a instruction sequence.

In an embodiment, CPU 104 is a processor for scheduling tasks running on the operation of system 100. CPU 104 works with UDOUs 105-107 to prepare sets of data for parallel vector processing by VPUs 101-103 as wells as orchestrates the processing by VPUs 101-103. In an embodiment, CPU 104 outputs control signals to UDOUs 105-107 and VPUs 101-103 via signal paths 108 and 110. In embodiments, CPU 104 schedules and dispatches tasks to VPUs 101-103 and configures UDOUs 105-107.

UDOUs 105-107 are responsible for moving/organizing sets of data in parallel to be processed by VPUs 101-103. In an embodiment, UDOUs 105-107 are integrated circuits that move data sets into level one data memory (L1DM) 101c (as described herein) and organize their data sets so that the data sets may be efficiently processed in a vector calculation of a VPU. The data stored in memory may represent values from a 5G signal received by an antenna in a cellular network in an embodiment. In an embodiment, organized data sets are input to VPUs 101-103 from UDOUs 105-107 via signal path 109.

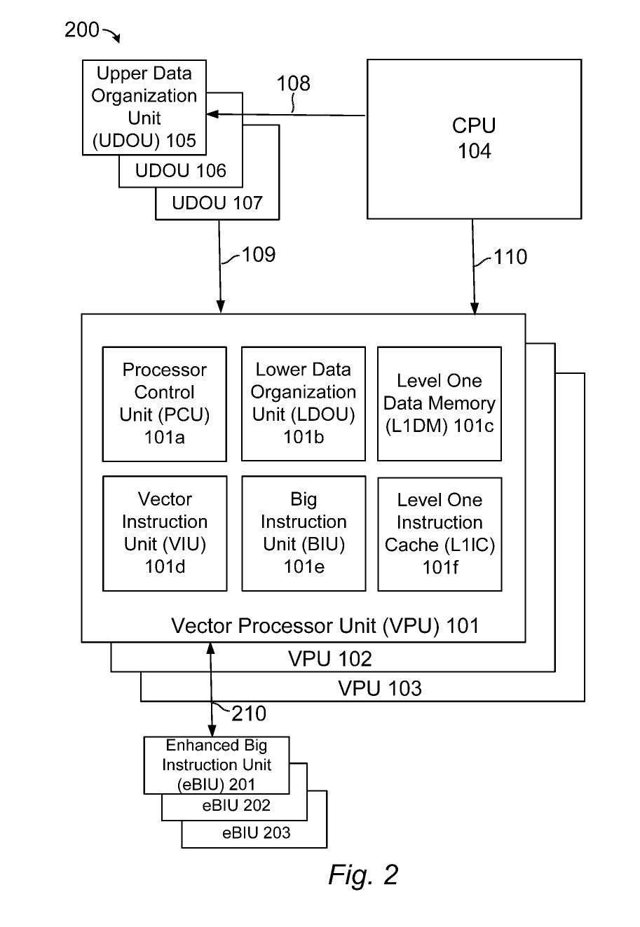

In an embodiment, VPU 101 includes processor control unit (PCU) 101a, lower data organization unit (LDOU) 101b, L1DM 101c, VIU 101d, BIU 101e and level one instruction cache (L1IC) 101f. The operation of these integrated circuits are described in detail herein and illustrated in FIGS. 2-5.

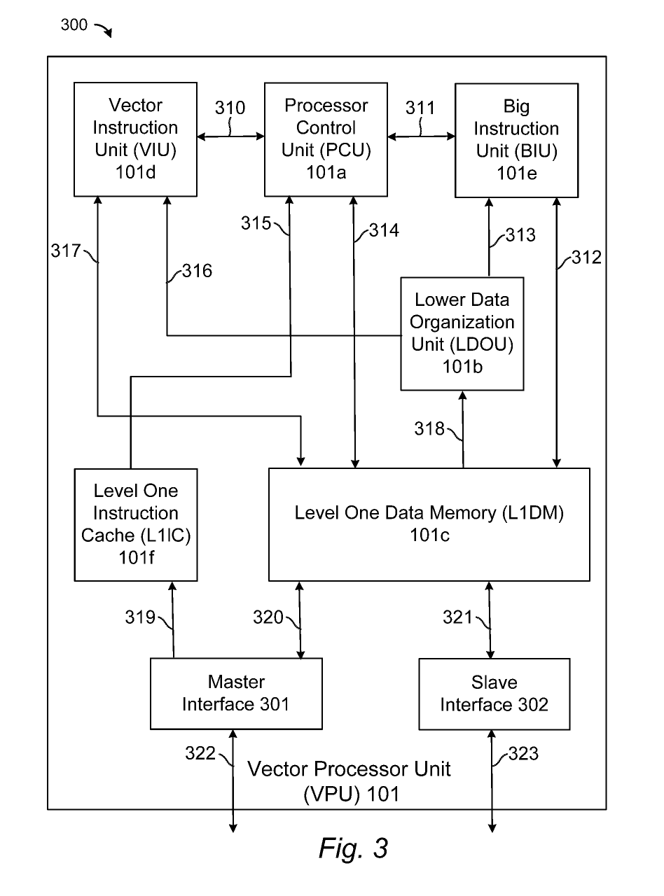

PCU 101a provides control signals to circuits of VPU 101 in embodiments. As illustrated in FIG. 3, PCU 101a may provide control signals to BIU 101e to configure a vector function to be performed. In embodiments, PCU 101a may receive control signals from CPU 104 via at least signal path 110 as shown in FIG. 1. PCU 101a as well as VIU 101d may read and/or write to L1DM 101c as well as memories outside of VPU 101. PCU 101a also fetches instructions through L1IC 101f in an embodiment.

LDOU 101b organizes the data in L1DM 101c, which may be received from UDOU 105 or generated by a calculation in VPU 101, and send the data to either VIU 101d or BIU 101e. In embodiments, LDOU 101b may not be included in VPU 101. In an embodiment, LDOU 101b reads data from L1DM 101c and/or memories outside of VPU 101. LDOU 101b also provides organized data to BIU 101e and VIU 101d in embodiments.

L1DM 101c is a memory that stores sets of data inside VPU 101 in an embodiment. In an embodiment, L1DM 101c is a level one data memory to store organized sets of data from UDOU 105. UDOU 105 moves bulk data or sets of data between L1DM 101c and memories outside VPU 101.

VIU 101d is a programmable integrated circuit that executes vector processing instructions. VIU 101d receives control/configure signals from PCU 101a. As described herein, VIU 101d uses a relatively small instruction set architecture and is used for less complex vector processing. In an embodiment, VIU 101d performs arithmetic functions such as a floating point operation, fixed point operation, summation, subtraction, multiplication and division.

BIU 101e is a programmable integrated circuit that performs the functions as described herein, including performing a selected vector function from a plurality of vector functions. In embodiments, BIU 101e may be configured in a few cycles and stall-able to wait for data in embodiments. BIU 101e works together with LDOU 101b. BIU 101e and VIU 101d are clock gated when they are idle in embodiments. BIU 101e is configured and controlled by PCU 101a in an embodiment. BIU 101e writes results to L1DM 101c as well as to outside memories in embodiments.

L1IC 101f is a memory, such as cache memory, that stores instructions or control information. In an embodiment, L1IC 101f is a level one cache circuit to store instructions from CPU 104.

In embodiments, one or more clock generation circuits outputs one or more clock signals having a plurality of clock cycles to synchronize or drive the circuits illustrated in FIG. 1 and herein. For example, a clock generation circuit provides a clock signal to drive BIU 101e and another clock generation circuit provides a clock signal to drive VPU 101.

FIG. 2 is a block diagram of an UL VPU system 200 having a set of extended big instruction units (eBIUs) according to embodiments of the present technology. In an embodiment, a set of eBIUs 201-203 are coupled to a set of VPUs 101-103 by signal path(s) 210. In embodiments, VPUs 101-103 share a pool of eBIUs 201-203 in a matured 5G stage that may require more extensive vector processing. For example, eBIUs 201-203 may perform functions such as channel estimation, Ruu and Ruu inversion as well as MIMO processing. In an embodiment, Ruu is an (interference+noise) covariance matrix and Ruu inversion is a matrix inversion of Ruu.

FIG. 3 is a block diagram of UL VPU architecture 300 according to embodiments of the present technology. In an embodiment, VPU 101 shown in FIG. 2 includes similar circuits described herein and illustrated in FIG. 1.

In an embodiment, VPU 101 communicates with UDOU 105 and CPU 104 via signal paths 322 and 323 coupled to master interface 301 and slave interface 302, respectively. In embodiments, master interface 301 and slave interface 302 are integrated circuits that transfers signals between VPU 101 and external to VPU 101. Master interface 301 may read and/or write to memories outside VPU 101 in embodiments. In an embodiment, slave interface 302 reads and/or writes data from/to L1DM 101c.

In an embodiment, signal paths 323 corresponds to signal path(s) 110 and 109 in embodiments. In embodiments, control signals are transferred from CPU 104 to slave interface 302 via signal path 323 and organized sets of data are also transferred from UDOU 105 to slave interface 302 via signal path 323. In embodiments, separate slave interfaces may be used. Similarly, results from processing, such as vector processing calculations, may be output from master interface 301 and slave interface 302 via signal paths 322 and 323. In embodiments, data and control/status signals may be similarly output from VPU 101.

Organized sets of data may be transferred from master interface 301 and slave interface 302 to L1DM 101c via signal paths 320 and 321 in embodiments. Instructions (and/or control signals including control information) may be similarly transferred from master interface 301 to L1IC 101f via signal path 319.

LDOU 101b reads sets of data from L1DM 101c via signal path 318 and organizes the data for a vector function or process to be performed by VIU 101d and/or BIU 101e in embodiments. In an embodiment, LDOU 101b outputs an organized set of data for a selected vector process or function to VIU 101d and/or BIU 101e via signal paths 316 and 313, respectively.

VIU 101d and BIU 101e may read/write data from/to L1DM 101c through signal path 317 and 312. BIU 101e may receive data from LDOU 101b via signal path 318.

PCU 101a fetches instructions (or control information) from L1IC 101f via signal path 315 in an embodiment. In an embodiment, an instruction may indicate an operation to be performed by VIU 101d or a vector function to be performed by BIU 101e. In embodiments, PCU 101a may send instructions to VIU 101d via signal path 310 and/or send control and/or configuration signals (instructions) to BIU 101e via signal path 311, respectively. In an embodiment, VIU 101d and BIU 101e outputs status signal to PCU 101a via signal paths 310 and 311. Data may be transferred between PCU 101a and L1DM 101c via signal path 314 in an embodiment. In an embodiment, signal path 314 may be separated into a first signal path to write data from PCU 101a to L1DM 101c and a second signal path to read data from L1DM 101c to PCU 101a.

PCU 101a fetches instructions from L1IC 101f as well as decodes instructions and execute controls change of flow (COF), scalar, load and store instructions in embodiments. PCU 101a may send read requests for VIU load instructions. PCU 101a may also receive status signals from circuits that indicates, but not limited to, a stall or idle status. PCU 101a may send instruction bundles to VIU 101d as well as send instructions to BIU 101e to configure/control BIU 101e. PCU 101a may also read/write to or from registers of BIU 101e in embodiments. Similarly, PCU 101a may read and/or write to L1DM 101c as well as read and/or write to memories outside VPU 101.

BIU 101e performs a selected vector processing function from a plurality of vector functions in response to a start signal received from PCU 101a. BIU 101e may receive data from LDOU 101b via signal path 313 and output the calculation results of the selected vector processing function via signal path 312. BIU 101e may send a job finish signal to PCU 101a on completion of the selected vector function.

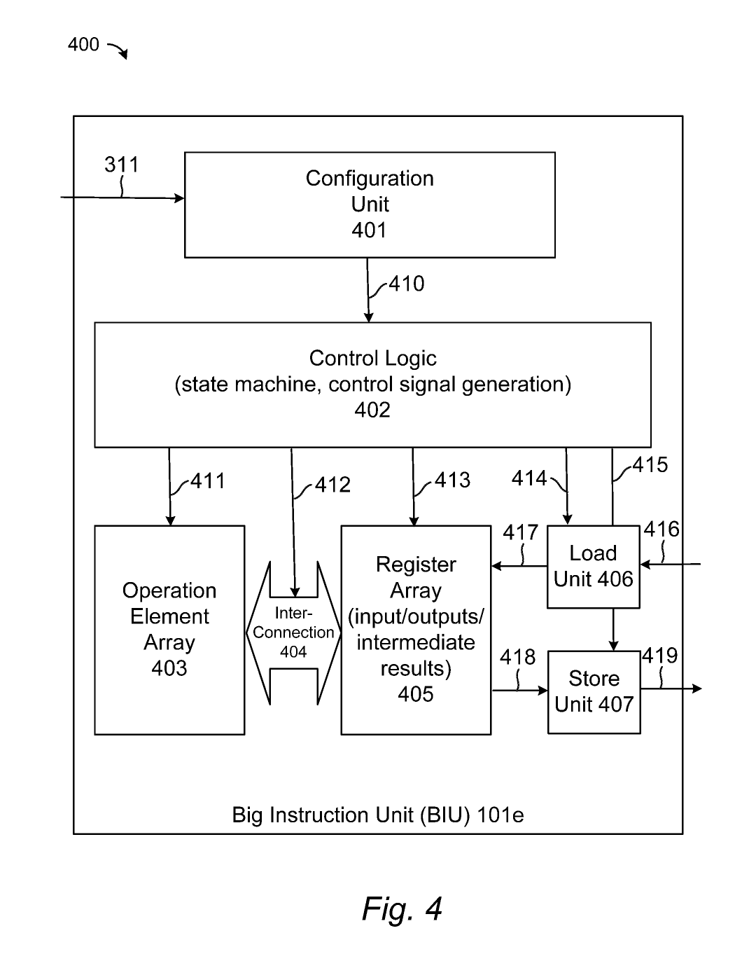

FIG. 4 is a block diagram of a BIU architecture 400 according to embodiments of the present technology. In an embodiment, BIU 101e as shown in FIG. 4 includes one or more of the following integrated circuits: configuration unit 401, control logic 402, operation element array 403, interconnection 404, register array 405, load unit 406 and store unit 407.

Configuration unit 401 receives one or more control/configuration signals or instructions from PCU 101a via signal path 311 in embodiments. In an embodiment, a control signal may include a selected vector function to perform from a plurality of vector functions that may be performed by BIU 101e. In an embodiment, a control signal may include variable values for the selected vector function. In embodiments, the vector function includes a relatively complex vector processing or calculation that may take over approximately 100 clock cycles to complete. Configuration unit 401 decodes the received instructions to configure and control BIU 101e. For example, configuration unit 401 may include an instruction via signal path 311 to prepare (or configure) for performing a transformation of a set of data (having a particular data set size) from a time domain to a frequency domain. The received instruction may include one or more values to be used in the vector function performed on a received set of data. Upon receiving instructions via signal path 311, configuration unit 401 may output the one or more control signals to control logic 402 via signal path 410.

Control logic 402 shapes a pipeline and/or data flow of BIU 101e in embodiments. Different selected vector functions of BIU 101e have different data flows and state machines. A selected vector function of BIU 101e is configured, at least in part, by setting up the corresponding state machine. Control logic 402 includes a plurality of state machines corresponding to a plurality of vector functions that may be performed by BIU 101e.

Each state machine in a plurality of state machines may include a control bit vector to generate control signals to control at least: 1) a data flow (interconnection 404) between operation element array 403 and register array 405; 2) load unit 406; and 3) store unit 407 in embodiments. In response to a selected state machine, control logic outputs respective control signals via signal paths 411, 412, 413, 414 and 415 to operation element array 403, interconnection 404, register array 405, load unit 406 and store unit 407, respectively.

Operational element array 403, interconnection 404 and register array 405 are configured, programmed or controlled for the selected vector function in response to one or more control signals from control logic 402 via signal paths 411, 412 and 413.

Load unit 406 reads a set of data from LDOU 101b via signal path 416 and outputs (writes) the set of data to register array 405 via signal path 417 in response to at least one control signal from control logic 402 via signal path 414. In an embodiment, signal path 416 shown in FIG. 4 corresponds to signal path 313 shown in FIG. 3.

Store unit 407 reads data or a result from register array 405 via signal path 418 and writes (or stores) the data to L1DM 101c or outside memory via signal path 419 in response to at least one control signal from control logic 402 via signal path 415. In an embodiment, signal path 419 shown in FIG. 4 corresponds to signal path 312 shown in FIG. 3.

In an embodiment, vector functions performed by BIU 101e may include relatively complex signal processing that may include vector calculations. For example, functions performed by BIU 101e may include receiver front-end processing such as filtering a data set to separate different radios, cancelling passive intermodulation (PIM) in a data set, transforming or converting a set of data in a time domain to a frequency domain (fast fourier transform (FFT)), and transforming or converting a set of data in an antenna domain to beam domain. Functions performed by BIU 101e may also include transmitter related signal processing.

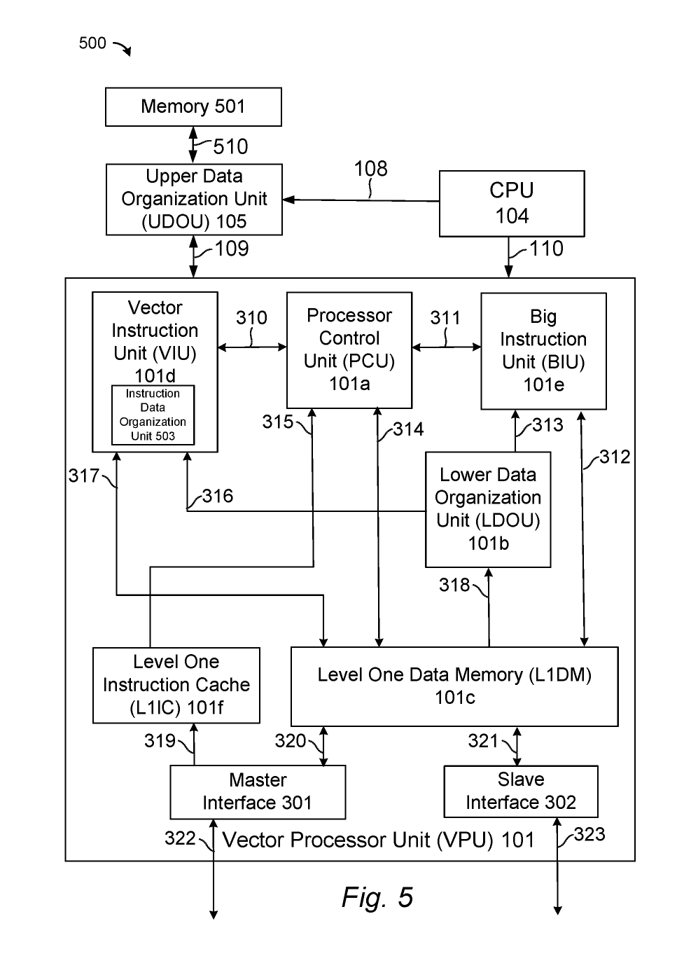

FIG. 5 is a block diagram of data organization system 500 according to embodiments of the present technology. In embodiments, data organization system 500 includes one or more data organization circuits: UDOU 105, LDOU 101b and instruction data organization unit (iDOU) 503 in which one or more may be used with and/or in a VPU 101. In an embodiment, iDOU 503 is an integrated circuit in VIU 101d. Data organization units organize data for processing by VPU 101.

In an embodiment, UDOU 105 retrieves and organizes a set of data according to first type of organization. The use of UDOU 105 alleviates the use of a large buffer in embodiments. UDOU 105 organizes retrieved data to form a data group or data set in specialty for parallel processing. In embodiments, UDOU 105 reads and organizes task level input data and writes data to L1DM 101c via signal paths 109 and 321. LDOU 101b reads data from L1DM 101c via signal path 318. UDOU 105 retrieves data via signal path 510 from memory 501 and organizes the data into data sets such as data blocks or matrices for vector processing. In an embodiment, UDOU 105 operates in parallel with the operation of core of VIU 101d.

Memory 501 may include level 2 (L2) cache, level 3 (L3) cache or double data rate (DDR) memory.

In an embodiment, LDOU 101b may retrieve and organize the data sets in L1DM 101c which are organized and moved in by UDOU 105 according to a second type of organization. In embodiments, the organized data sets from LDOU 101b may be input into a vector core of VIU 101d via signal path 316 for processing of a selected vector function. In embodiments, a vector core may be included in VIU 101d and/or BIU 101e. In an embodiment, LDOU 101b may prepare the set of data to be processed in parallel by a vector core. In an embodiment, LDOU 101b inputs the set of data into registers associated with or in vector core. In an embodiment, LDOU 101b operates in parallel with the operation of vector core.

In an alternate embodiment, data sets organized by LDOU 101b may be processed by iDOU 503 for organizing the data sets before processing by VIU 101d according to a third type of organization. In an embodiment, iDOU 503 organizes a data set already in registers into a vector to be processed by other instructions in VIU 101d.

L1DM 101c includes configuration instructions for data movement and organization in an embodiment. In an embodiment, a scheduler core is included in CPU 104 that outputs control or configuration signals for configuring and/or controlling one or more data organization units

In embodiments, results from selected vector functions performed by a vector core on received data sets may be output to memory 501 directly or through UDOU 105 in embodiments. In an embodiment, signal paths 109 and 110 are coupled to interface 302.

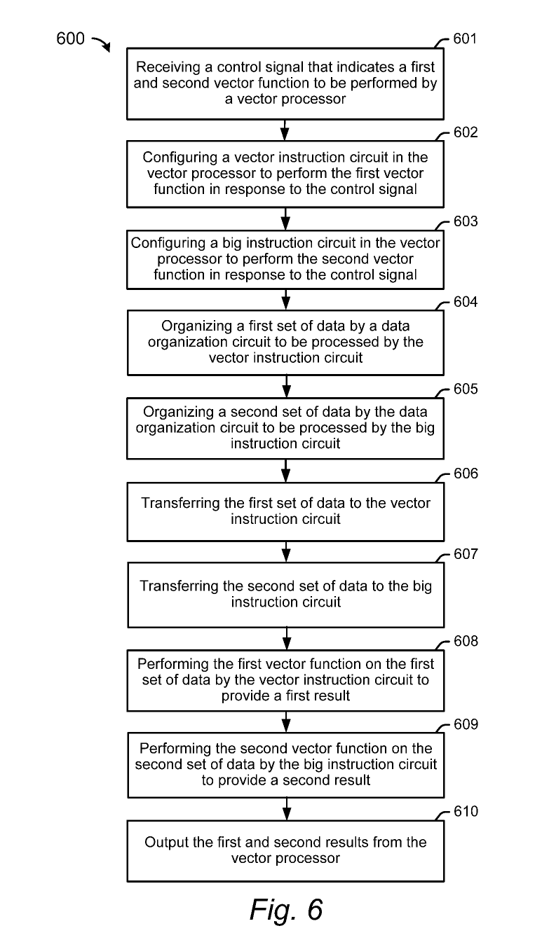

FIGS. 6, 7 and 8 are flowcharts that illustrate methods according to embodiments of the present technology. In embodiments, flowcharts in FIGS. 6, 7 and 8 are methods performed, at least partly, by hardware illustrated and described herein.

FIG. 6 is a flowchart that illustrates a method 600 of operating a UL VPU according to embodiments of the present technology.

In FIG. 6 at 601, a control signal is received that indicates a first and second vector function to be performed by a vector processor. In an embodiment, PCU 101a in VPU 101 receives a control signal from CPU 104 via L1IC 101f in an embodiment as illustrated in FIGS. 1 and 3.

At 602 a vector instruction circuit is configured in the vector processor to perform the first vector function in response to the control signal. In an embodiment, VIU 101d is configured in response to a control signal received from PCU 101a via signal path 310 as described herein and illustrated in FIG. 3.

At 603 a big instruction circuit is configured in the vector processor to perform the second vector function in response to the control signal. In an embodiment, BIU 101e is configured in response to a control signal received from PCU 101a via signal path 311 as described herein and illustrated in FIG. 3.

At 604 a first set of data is organized by a data organization circuit to be processed by the vector instruction circuit. In an embodiment, LDOU 101b organizes a first set of data from L1DM 101c to be processed by VIU 101d as described herein and illustrated in FIG. 3.

At 605 a second set of data is organized by the data organization circuit to be processed by the big instruction circuit. In an embodiment, LDOU 101b organizes the second set of data from L1DM 101c to be processed by BIU 101e as described herein and illustrated in FIG. 3.

At 606 the first set of data is transferred to the vector instruction circuit. In an embodiment, LDOU 101b transfers an organized first set of data to be processed to VIU 101d via signal path 316 as described herein and illustrated in FIG. 3.

At 607 the second set of data is transferred to the big instruction circuit. In an embodiment, LDOU 101b transfers an organized second set of data to be processed to BIU 101e via signal path 313 as described herein and illustrated in FIG. 3.

At 608 the first vector function is performed on the first set of data by the vector instruction circuit to provide a first result. In an embodiment, VIU 101d performs a first vector function on the first set of data to provide a first result in response to a control signal from PCU 101a via signal path 310 as described herein and illustrated in FIG. 3.

At 609 the second vector function is performed on the second set of data by the big instruction circuit to provide a second result. In an embodiment, BIU 101e performs a second vector function on the second set of data to provide a second result in response to a control signal from PCU 101a via signal path 311 as described herein and illustrated in FIG. 3.

At 610 the first and second results are output from the vector processor. In an embodiment, the first and second results are output from VIU 101d and BIU 101e via L1DM 101c.

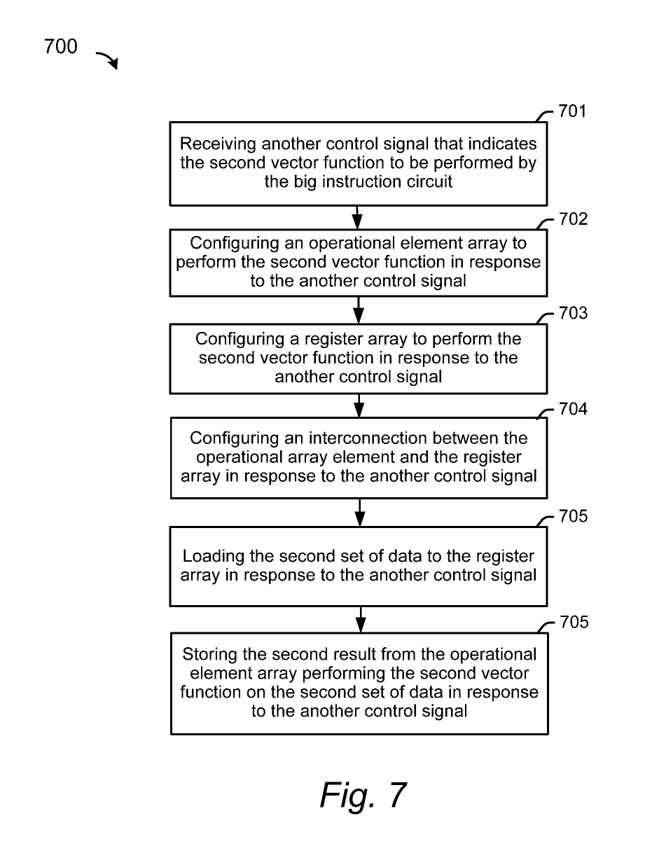

FIG. 7 is a flowchart that illustrates a method 700 of operating a BIU according to embodiments of the present technology.

At 701 another control signal is received that indicates the second vector function to be performed by the big instruction circuit. In an embodiment, another signal is received by configuration unit 401 via signal path 311 from PCU 101a illustrated in FIGS. 3-4.

At 702 an operational element array is configured to perform the second vector function in response to another control signal. In an embodiment, control logic 402 outputs a control signal via signal path 411 to operation element array 403 in response to a control signals received via signal paths 311 and 410 by configuration unit 401 and control logic 402.

At 703 a register array is configured to perform the second vector function in response to another control signal. In an embodiment, register array 405 is configured in response to in response to a control signals received via signal paths 311 and 410 by configuration unit 401 and control logic 402.

At 704 an interconnection is configured between the operational array element and the register array in response to another control signal. In an embodiment, interconnection 404 is configured in response to a control signals received via signal paths 311 and 410 by configuration unit 401 and control logic 402.

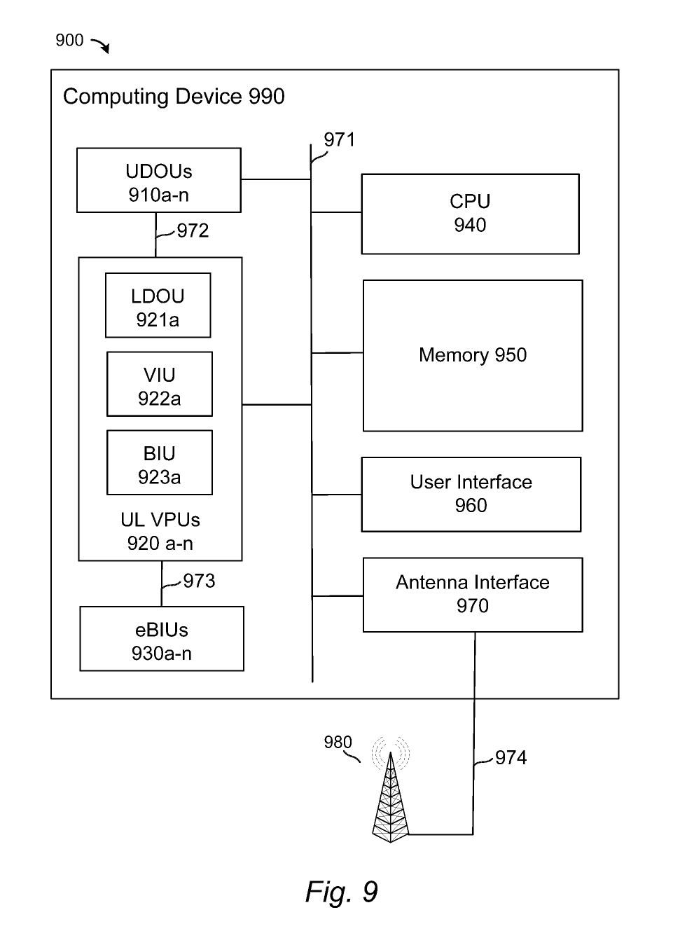

At 705 the second set of data is loaded to the register array in response to another control signal. In an embodiment, the second set of data is loaded from memory, such as memory 950 shown in FIG. 9, by load unit 406 via signal path 416 (and 971 in FIG. 9) in response to a control signal received via signal path 414 from control logic 402. In an embodiment, load unit 406 outputs the second set of data to register array 405 via signal path 417 in response to a control signal from control logic 402.

At 706 the second result is stored from the operational element array performing the second vector function on the second set of data in response to another control signal. In an embodiment, the second result is stored to memory, such as memory 950 shown in FIG. 9, by store unit 407 via signal path 419 (and 971 in FIG. 9) in response to a control signal received via signal path 415 from control logic 402. In an embodiment, store unit 407 outputs a second result from register array 405 via signal paths 418 and 419 in response to a control signal from control logic 402.

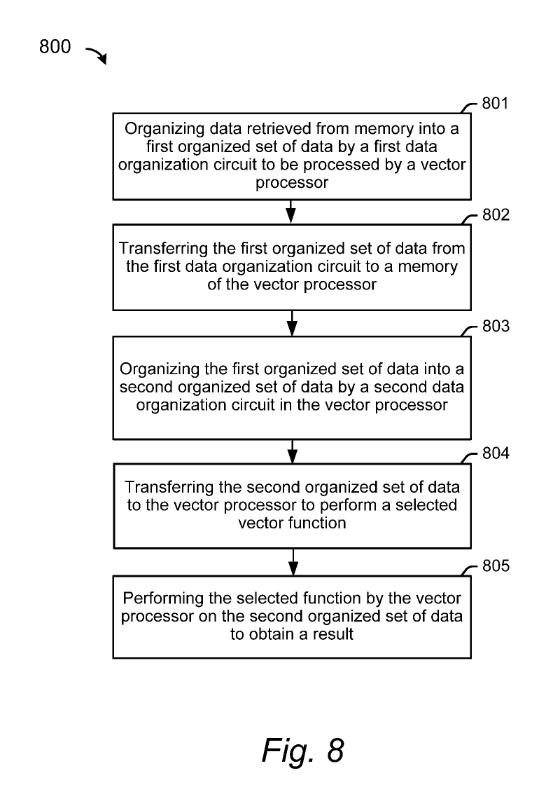

FIG. 8 is a flowchart that illustrates a method 800 of operating a data organization system according to embodiments of the present technology.

At 801 data retrieved from memory is organized into a first organized set of data by a first data organization circuit to be processed by a vector processor. In an embodiment UDOU 105 retrieves data and organizes a first set of data from memory 501 via signal path 510.

At 802 the first organized set of data is transferred from the first data organization circuit to memory, such as L1DM 101c, of the vector processor. In an embodiment, UDOU 105 illustrated by FIGS. 1 and 5 transfers the first organized set of data from UDOU 105 to VPU 101, in particular L1DM 101c.

At 803 the first organized set of data is organized into a second organized set of data by a second data organization circuit in the vector processor. In an embodiment, LDOU 101b reads the first organized set of data from L1DM 101c via signal path 318 and organizes the first set of data into a second organized set of data.

At 804 the second organized set of data is transferred to the vector processor, such as VIU 101d and/or BIU 101e, to perform a selected vector function. In an embodiment, a second organized set of data is transferred from LDOU 101b to VIU 101d via signal path 316 as shown in FIG. 5.

At 805 the selected vector function is performed by the vector processor on the second organized set of data to obtain a result. In an embodiment, BIU 101e performs the selected vector function from a plurality of vector functions on the second organized set of data and outputs the result from VPU 101 as described herein.

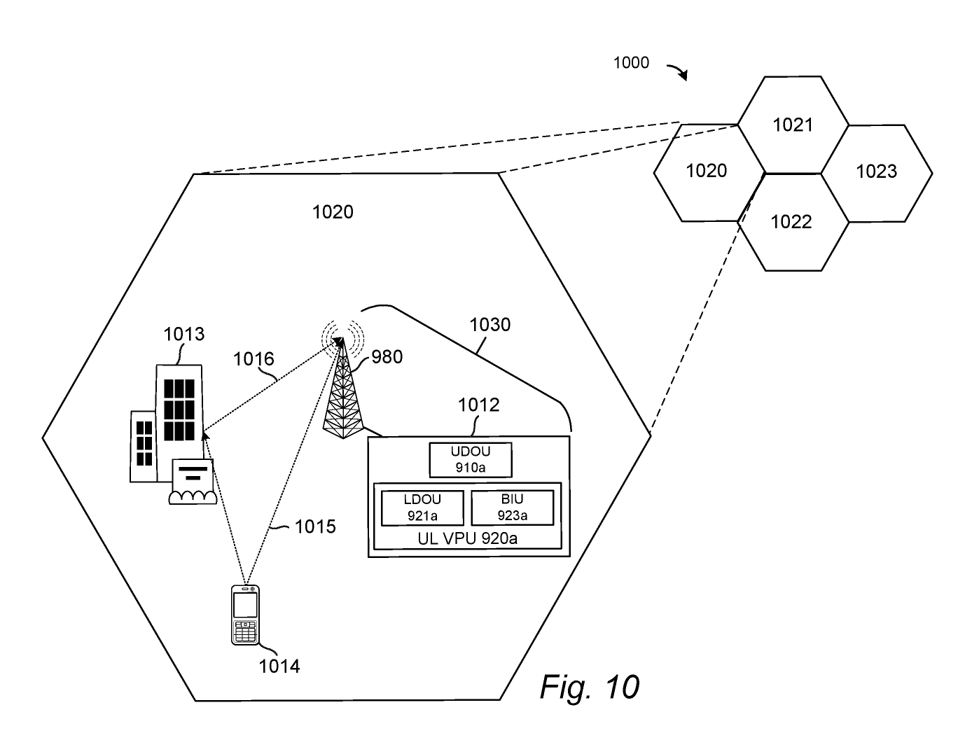

FIG. 9 illustrates a hardware architecture 900 for a computing device 990 that includes UDOUs 910a-n, UL VPUs 920a-n and eBIUs 9301-n. In an embodiment, UL VPU 920a-n includes LDOU 921a, VIU 922a and BIU 923a. In an embodiment, computing device 990 is included in a base station having an antenna that communicates with user equipment in a cellular network. In an embodiment, computing device 990 processes cellular signals, such as 5G signals in a cellular network, such as cellular network 1000 shown in FIG. 10.

Computing device 990 may also include central processor unit (CPU) 940, memory 950, a user interface 960 and antenna interface 970 coupled by signal path 971 to UDOUs 910a-n and UL VPUs 920a-n. In an embodiment, UL VPUs 920a-n are couple to UDOUs 910a-n by signal path 972 and to eBIUs 930a-n by signal path 973. Signal path 971 may include a bus for transferring signals having one or more type of architectures, such as a memory bus, memory controller, a peripheral bus or the like. In embodiments, signal paths 972 and 973 may include a bus and/or direct connection.

In embodiments, a signal path (described herein and/or illustrated in the figures) may include, but is not limited to, one or more of a wire, trace, transmission line, track, pad, layer, lead, metal, portion of a printed circuit board or assembly, conducting material and other material that may transfer or carry an electrical signal, light pulse and/or frequency. In embodiments, a signal path may form one or more geometric shapes, such as a line or multiple connected lines, and may or may not have arrows indicating signal flow direction. In embodiments, a signal path may by unidirectional or bidirectional in transferring signals between circuits and within circuits.

Computing device 990 may be implemented in various embodiments. Computing devices may utilize all of the hardware or software components, or a subset of the components in embodiments. Levels of integration may vary depending on an embodiment. For example, memory 950 may be divided into many more memories. Furthermore, a computing device 990 may contain multiple instances of a component, such as multiple processors (cores), memories, transmitters, receivers, etc. Computing device 990 may comprise a processor equipped with one or more input/output devices, such as network interfaces, storage interfaces, and the like.

In an embodiment, computing device 990 may be a mainframe computer that accesses a large amount of data related to a cellular network stored in a database. In an alternate embodiment, computing device 990 may be embodied as different type of computing device. In an embodiment, types of computing devices include but are not limited to, tablet, netbook, laptop, desktop, embedded, server and/or super (computer).

In an embodiment, antenna interface 970 obtains signals or values from antenna 980 via signal path 974 in an embodiment. In an embodiment, antenna interface 970 include one or more analog-to-digital converters and/or one or more transceivers to convert analog signals received by antenna 980 to digital values or data that are transferred by antenna interface 970 and stored in memory 950. In an embodiment, antenna interface 970 obtains data values from a 5G signal received at antenna 980 and stores the data value in memory 960 to be organized and processed according to embodiments of the present technology.

Memory 950 stores data received from antenna interface 970 in an embodiments. In embodiments, computer programs such as an operating system having application(s) and/or other computer programs are also stored in memory 950.

Memory 950 stores data accessed by at least UDOUs 910a-n and UL VPUs 920a-n. In an embodiment, data stored in memory 950 may be accessed by CPU 940 as well as user interface 960.

In an embodiment, CPU 940 may include one or more types of electronic processors having one or more cores. In an embodiment, CPU 940 is an integrated circuit processor that executes (or reads) computer instructions and/or data that may be included in code and/or computer programs stored on a non-transitory memory to provide at least some of the functions described herein. In an embodiment, CPU 940 is a multi-core processor capable of executing multiple threads. In an embodiment, CPU 940 is a digital signal processor, baseband circuit, field programmable gate array, digital logic circuit and/or equivalent.

A thread of execution (thread or hyper thread) is a sequence of computer instructions that can be managed independently in one embodiment. A scheduler, which may be included in an operating system, may also manage a thread. A thread may be a component of a process, and multiple threads can exist within one process, executing concurrently (one starting before others finish) and sharing resources such as memory, while different processes do not share these resources. In an embodiment, the threads of a process share its instructions (executable code) and its context (the values of the process's variables at any particular time).

In a single core processor, multithreading is generally implemented by time slicing (as in multitasking), and the single core processor switches between threads. This context switching generally happens often enough that users perceive the threads or tasks as running at the same time. In a multiprocessor or multi-core processor, multiple threads can be executed in parallel (at the same instant), with every processor or core executing a separate thread at least partially concurrently or simultaneously.

Memory 950, as well as other memories described herein, may comprise any type of system memory such as static random access memory (SRAM), dynamic random access memory (DRAM), synchronous DRAM (SDRAM), read-only memory (ROM), a combination thereof, or the like. In an embodiment, a memory 950 may include ROM for use at boot-up, and DRAM for program and data storage for use while executing computer instructions. In embodiments, memory 950 is non-transitory or non-volatile integrated circuit memory storage.

Further, memory 950 may comprise any type of memory storage device configured to store data, computer programs including instructions, and other information and to make the data, computer programs, and other information accessible via signal path 971. Memory 950 may comprise, for example, one or more of a solid state drive, hard disk drive, magnetic disk drive, optical disk drive, or the like.

Computing device 990 may also include one or more network interfaces which may comprise wired links, such as an Ethernet cable or the like, and/or wireless links to access a network. In an embodiment, a network interface is included in antenna interface 970. A network interface allows computing device 990 to communicate with remote computing devices and/or other cellular networks. For example, a network interface may provide wireless communication via one or more transmitters/transmit antennas and one or more receivers/receive antennas.

In embodiments, functions described herein are distributed to other or more computing devices. In embodiments, computing device 990 may act as a server that provides a service while one or more UE, computing devices and/or associated base stations may act as a client. In an embodiment, computing device 990 and another computing device may act as peers in a peer-to-peer (P2P) relationship.

User interface 960 may include computer instructions as well as hardware components in embodiments. A user interface 960 may include input devices such as a touchscreen, microphone, camera, keyboard, mouse, pointing device and/or position sensors. Similarly, a user interface 960 may include output devices, such as a display, vibrator and/or speaker, to output images, characters, vibrations, speech and/or video as an output. A user interface 960 may also include a natural user interface where a user may speak, touch or gesture to provide input.

FIG. 10 illustrates a system including a cellular network 1000 having a plurality of cells 1020-1023 forming a wireless network according to embodiments of the present technology. FIG. 10 also illustrates an expanded view of cell 1020 having a base station 1030 that communicates with one or more UEs, such as UE 1014, in cell 1020. A base station 1030 may include antenna 980 coupled to computing device 1012 in an embodiment.

Antenna 980 may include a plurality of directional antennas or antenna elements and may be coupled to an antenna tower or other physical structure in embodiments. Antenna 980 may transmit and receive signals, such as orthogonal frequency division multiplexing OFDM or 5G signals, to and from UEs in cell 1020 in response to electronic signals from and to computing device 1012. In an embodiment, antenna 980 includes a multi-input and multi-output (MIMO) antenna.

In embodiments, base station 1030 includes one or more transceivers coupled to antenna 980 to transmit and receive RF signals to and from UE 1014 in cell 1020. Computing device 1012 may be electronically coupled to other antennas and/or other cells (base stations), such as antennas in cells 1021-1023, in alternate embodiments.

Cell 1020 may cover a very different radio environment than one or more cells 1021-1023. For example, cell 1020 may cover a large urban area with many large and irregular spaced structures, such as buildings 1013; while, one or more cells 1021-1023 may cover rural areas that may include a relatively flat topography with very few high structures. Because of the relatively complex radio environment of cell 1020, signals transmitted by UE 1014 in cell 120 may reflect or form a multipath in arriving at antenna 980. For example, a signal transmitted by UE 1014 at a particular geographical location may result in multiple signals arriving at antenna 980 at different times and angles, or rays. A signal transmitted from UE 1014 may arrive at antenna 980 as at least two different signals 1015 and 1016 with different angles of arrival and relative delays. Signal 1016 may arrive at antenna 980 as a reflected and delayed signal from buildings 1013.

According to embodiments of the present technology, computing device 1012 corresponds to computing device 990 shown in FIG. 9 and described herein. In particular, computing device 1012 includes UDOU 910a and UL VPU 920a having LDOU 921a and BIU 923a to process signals or data values received from antenna 980.

In embodiments, a UE 1014 is also known as mobile station (MS). In an embodiment, UE 1014 conforms to a SIMalliance, Device Implementation Guide, June 2013 (SIMalliance) specification. In other embodiments, UE 1014 does not conform to the SIMalliance specification.

In embodiments, base station 1030 may be second generation (2G), third generation (3G), fourth generation (4G) and/or 5G base station. In embodiments, different types of cellular technologies may be used, such as Global System for Mobile Communications (GSM), code division multiple access (CDMA), Time division multiple access (TDMA) and Advanced Mobile Phone System (AMPS) (analog). In embodiments, different types of digital cellular technologies may be used, such as: GSM, General Packet Radio Service (GPRS), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN).

In embodiments, base station 1030 may be an E-UTRAN Node B (eNodeB), Node B and/or Base Transceiver Station (GBTS) BS. A GBTS may operate a variety of type's wireless technology, such as CDMA, GSM, Worldwide Interoperability for Microwave Access (WiMAX) or Wi-Fi. A GBTS may include equipment for the encryption and decryption of communications, spectrum filtering equipment, antennas and transceivers. A GBTS typically has multiple transceivers that allow it to serve many of the cell's different frequencies and sectors.

Computing device 1012 may communicate or transfers information by way of cellular network 1000 or an alternate network in embodiments. In an embodiment, a network may include a plurality of base stations in a cellular network or geographical regions and associated electronic interconnections. In an embodiment, a network may be wired or wireless, singly or in combination. In an embodiment, a network may include the Internet, a wide area network (WAN) or a local area network (LAN), singly or in combination.

In an embodiment, a network may include a High Speed Packet Access (HSPA) network, or other suitable wireless systems, such as for example Wireless Local Area Network (WLAN) or Wi-Fi (Institute of Electrical and Electronics Engineers' (IEEE) 802.11x). In an embodiment, computing device 1012 uses one or more protocols to transfer information or packets, such as Transmission Control Protocol/Internet Protocol (TCP/IP) packets.

Advantages of the present technology may include, but are not limited to, providing an ultra lean vector processor in a cellular network that enables front end processing in early stages of 5G technology as well as vector intensive processing that may occur at the mature stages of the 5G technology.

The flowcharts and block diagrams in the figures illustrate the architecture, functionality, and operation of possible implementations of a device, apparatus, system, computer-readable medium and method according to various aspects of the present disclosure. In this regard, each block (or arrow) in the flowcharts or block diagrams may represent operations of a system component, software component or hardware component for implementing the specified logical function(s). It should also be noted that, in some alternative implementations, the functions noted in the block may occur out of the order noted in the figures. For example, two blocks (or arrows) shown in succession may, in fact, be executed substantially concurrently, or the blocks (or arrows) may sometimes be executed in the reverse order, depending upon the functionality involved. It will also be noted that each block (or arrow) of the block diagrams and/or flowchart illustration, and combinations of blocks (or arrows) in the block diagram and/or flowchart illustration, can be implemented by special purpose hardware-based systems that perform the specified functions or acts, or combinations of special purpose hardware and computer instructions.

It will be understood that each block (or arrow) of the flowchart illustrations and/or block diagrams, and combinations of blocks (or arrows) in the flowchart illustrations and/or block diagrams, may be implemented by non-transitory computer instructions. These computer instructions may be provided to and executed (or read) by a processor of a general purpose computer (or computing device), special purpose computer, or other programmable data processing apparatus to produce a machine, such that the instructions executed via the processor, create a mechanism for implementing the functions/acts specified in the flowcharts and/or block diagrams.

As described herein, aspects of the present disclosure may take the form of at least a system, device having one or more processors executing instructions stored in non-transitory memory, a computer-implemented method, and/or non-transitory computer-readable storage medium storing computer instructions.

Non-transitory computer-readable media includes all types of computer-readable media, including magnetic storage media, optical storage media, and solid state storage media and specifically excludes signals. It should be understood that software including computer instructions can be installed in and sold with a computing device having computer-readable storage media. Alternatively, software can be obtained and loaded into a computing device, including obtaining the software via a disc medium or from any manner of network or distribution system, including, for example, from a server owned by a software creator or from a server not owned but used by the software creator. The software can be stored on a server for distribution over the Internet, for example.

More specific examples of the computer-readable medium include the following: a portable computer diskette, a hard disk, a random access memory (RAM), ROM, an erasable programmable read-only memory (EPROM or Flash memory), an appropriate optical fiber with a repeater, a portable compact disc read-only memory (CD-ROM), an optical storage device, a magnetic storage device, or any suitable combination thereof.

Non-transitory computer instructions used in embodiments of the present technology may be written in any combination of one or more programming languages. The programming languages may include an object oriented programming language such as Java, Scala, Smalltalk, Eiffel, JADE, Emerald, C++, CII, VB.NET, Python, R or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The computer instructions may be executed entirely on the user's computer (or computing device), partly on the user's computer, as a stand-alone software package, partly on the user's computer and partly on a remote computer, or entirely on the remote computer or server. In the latter scenario, the remote computer may be connected to the user's computer through any type of network, or the connection may be made to an external computer (for example, through the Internet using an Internet Service Provider) or in a cloud computing environment or offered as a service such as a Software as a Service (SaaS).

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Additional embodiments are illustrated herein by the following clauses.

Clause 1. An apparatus comprising a central processor to provide a first and second control signal. One or more data organizers organizes and moves a first set of data and a second set of data in response to the first control signal. One or more vector processors receives the first set of data and the second set of data from the one or more data organizers. A first vector processor in the one or more vector processors includes a first instruction circuit that executes a first plurality of vector functions. A first vector function is selected from the first plurality of vector functions to process the first set of data in response to the second control signal. A second instruction circuit executes a second plurality of vector functions. A second function is selected from the second plurality of vector functions to process the second set of data in response to the second control signal.

Clause 2. The apparatus of clause 1, wherein the first plurality of vector functions include a plurality of signal processing functions that include a vector processing of the first set of data and wherein the second plurality of functions include a fixed point vector processing function or a floating point vector processing function of the second set of data.

Clause 3. The apparatus of any one of clauses 1-2, wherein each of the vector functions in the first plurality of vector functions processes the first set of data in over approximately a hundred clock cycles of a clock signal to obtain a result.

Clause 4. The apparatus of any one of clauses 1-3, wherein the second instruction circuit uses no more than approximately five clock cycles to perform each of the vector functions in the second plurality of vector functions.

Clause 5. The apparatus of any one of clauses 1-4, wherein the first instruction circuit comprises a configuration circuit that outputs a configuration signal in response to the second control signal. A control logic outputs a third, fourth, fifth, sixth and seventh control signal in response to the configuration signal. An operation element array is configured in response to the third control signal and a register array stores the first set of data or a result in response to the fifth control signal. An interconnection is configured between the operation elements array and the register array in response to the fourth control signal. A load circuit writes the first set of data to the register array in response to the sixth control signal and a store circuit stores the result from the register array in response to the seventh control signal.

Clause 6. The apparatus of any one of clauses 1-5, wherein the first vector processor comprises a first interface that receives the second set of data from the one or more data organizers and a data cache stores the second set of data from the first interface. A vector data organization circuit receives the second set of data from the data cache. A second interface receives the second control signal and an instruction cache stores control information of the second control signal from the second interface. A processing control circuit receives the control information from the instruction cache and outputs a first instruction to the first instruction circuit to select the first vector function. The processing control circuit outputs a second instruction to the second instruction circuit to select the second vector function in response to the control information.

Clause 7. The apparatus of any one of clauses 1-6, further comprising one or more instruction circuits, coupled to the vector processor, to execute a third plurality of vector functions. A third vector function is selected from the third plurality of vector functions to process a third set of data in response to a third control signal from the vector processor.

Clause 8. The apparatus of any one of clauses 1-7, wherein the first plurality of vector functions includes at least one of: filtering the first set of data, cancelling passive intermodulation (PIM) in the first set of data, converting the first set of data from a time domain to a frequency domain and converting the first set of data from an antenna domain to a beam domain and wherein the second plurality of vector functions include at least one of a: floating point operation of the second set of data, fixed point operation of the second set of data, summation of the second set of data, subtraction of the second set of data, multiplication of the second set of data and division of the second set of data

Clause 9. The apparatus of any one of clauses 1-8, further comprises a processing control circuit to decode and execute change of flow (COF), scalar, load and store instructions.

Clause 10. The apparatus of any one of clauses 1-9, wherein the apparatus is included in a base station having an antenna to receive a 5G signal from a user equipment in a cellular network. The first set of data and the second set of data are obtained from the 5G signal.

Clause 11. An integrated circuit to process a set of data received from an antenna in a cellular network. The integrated circuit comprises a data memory to store the set of data and a data organization circuit to organize the set of data from the data memory. A first instruction circuit executes a first vector processing function on the set of data from the data organization circuit from a first plurality of functions. A second instruction circuit executes a second vector processing function on the set of data from the data organization circuit from a second plurality of functions. An instruction cache stores control information represented by a first control signal. A processor control circuit receives the control information from the instruction cache. The processor control circuit outputs a second control signal to the first instruction circuit to select the first vector processing function in response to receipt of the control information from the instruction cache. The processor control circuit outputs a third control signal to the second instruction circuit to select the second vector processing function in response to receipt of the control information from the instruction cache. The first plurality of functions is different than the second plurality of functions.

Clause 12. The integrated circuit of clause 11, wherein the first plurality of functions include signal processing vector functions and the second plurality of functions include fixed point or floating point arithmetic vector functions.

Clause 13. The integrated circuit of any one of clauses 11-12, wherein the signal processing vector functions include at least one of: filtering the set of data, converting the set of data in a time domain to a frequency domain, cancelling passive intermodulation (PIM) in the set of data, and converting the set of data in an antenna domain to a beam domain.

Clause 14. The integrated circuit of any one of clauses 11-13, wherein the first instruction circuit comprises a configuration circuit to output a configuration signal in response to the second control signal. A control logic outputs a fourth, fifth, sixth, seventh and eighth control signal in response to the configuration signal. An operation element array is configured in response to the fourth control signal and a register array stores the set of data or a result in response to the fifth control signal. An interconnection is configured between the operation elements array and the register array in response to the sixth control signal. A load circuit writes the set of data to the register array in response to the seventh control signal and a store circuit stores the result from the register array in response to the eighth control signal.

Clause 15. The integrated circuit of any one of clauses 11-14, wherein the set of data is received from a set of data organization circuits and the first control signal is received from a central processor.

Clause 16. The integrated circuit of any one of clauses 11-15, wherein the integrated circuit is included is included in a plurality of integrated circuits coupled to a set of a third instruction circuits, each third instruction circuit to execute a third function on the set of data from a third plurality of functions, and wherein the third plurality of functions includes at least one of channel estimation, Ruu, Ruu inversion and multiple-input and multiple-output (MIMO) processing.

Clause 17. A method for operating a vector processor comprising receiving a control signal that indicates a first and second vector function that are to be performed by the vector processor. A vector instruction circuit in the vector processor is configured to perform the first vector function in response to the control signal. A big instruction circuit in the vector processor is configured to perform the second vector function in response to the control signal. A first set of data is organized by a data organization circuit to be processed by the vector instruction circuit. A second set of data is organized by the data organization circuit to be processed by the big instruction circuit. The first vector function is performed on the first set of data by the vector instruction circuit to provide a first result and the second vector function is performed on the second set of data by the big instruction circuit to provide a second result. The first and second results are output from the vector processor.

Clause 18. The method of clause 17, wherein the first vector function is selected from a first plurality of functions that may be performed by the vector instruction circuit that includes at least one of: fixed point or floating point arithmetic vector functions on the first set of data, and wherein the second vector function is selected from a second plurality of functions that may be performed by the big instruction circuit that includes at least one of filtering the second set of data, converting the second set of data from a time domain to a frequency domain, cancelling passive intermodulation (PIM) in the second set of data and converting the second set of data from an antenna domain to a beam domain.

Clause 19. The method of any one of clauses 17-18, wherein performing the second vector function on the second set of data by the big instruction circuit to provide the second result comprises the steps of receiving another control signal that indicates the second vector function to be performed by the big instruction circuit. An operational element array is configured to perform the second vector function in response to another control signal. A register array is configured to perform the second vector function in response to another control signal. An interconnection is configured between the operational array element and the register array in response to another control signal. The second set of data is loaded into the register array in response to another control signal. The second result is stored from the operational element array performing the second vector function on the second set of data in response to another control signal.

Clause 20. The method of any one of clauses 17-19, wherein the first set of data and the second set of data are obtained from a cellular signal received by an antenna from a user equipment in a cellular network, and wherein the vector processor is included in a base station coupled to the antenna in the cellular network.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Although the subject matter has been described in language specific to structural features and/or methodological steps, it is to be understood that the subject matter defined in the appended claims is not necessarily limited to the specific features or steps (acts) described above. Rather, the specific features and steps described above are disclosed as example forms of implementing the claims.

What is claimed is:

1. An apparatus comprising:
a central processor to provide a first and second control signal;
one or more data organizers to organize and move a first set of data and a second set of data in response to the first control signal; and
one or more vector processors to receive the first set of data and the second set of data from the one or more data organizers, wherein a first vector processor in the one or more vector processors includes:
a first instruction circuit to execute a first plurality of vector functions, wherein a first vector function is selected from the first plurality of vector functions to process the first set of data in response to the second control signal, and
a second instruction circuit to execute a second plurality of vector functions, wherein a second function is selected from the second plurality of vector functions to process the second set of data in response to the second control signal.

2. The apparatus of claim 1, wherein the first plurality of vector functions include a plurality of signal processing functions that include a vector processing of the first set of data, and
wherein the second plurality of functions include a fixed point vector processing function or a floating point vector processing function of the second set of data.

3. The apparatus of claim 1, wherein each of the vector functions in the first plurality of vector functions processes the first set of data in over approximately a hundred clock cycles of a clock signal to obtain a result.

4. The apparatus of claim 3, wherein the second instruction circuit uses no more than approximately five clock cycles to perform each of the vector functions in the second plurality of vector functions.

5. The apparatus of claim 1, wherein the first instruction circuit comprises:
a configuration circuit to output a configuration signal in response to the second control signal;
a control logic to output a third, fourth, fifth, sixth and seventh control signal in response to the configuration signal;
an operation element array to be configured in response to the third control signal;
a register array to store the first set of data or a result in response to the fifth control signal;
an interconnection to be configured between the operation elements array and the register array in response to the fourth control signal;
a load circuit to write the first set of data to the register array in response to the sixth control signal; and
a store circuit to store the result from the register array in response to the seventh control signal.

6. The apparatus of claim 5, wherein the first vector processor comprises:
a first interface to receive the second set of data from the one or more data organizers;
a data memory to store the second set of data from the first interface;
a vector data organization circuit to receive the second set of data from the data memory;
a second interface to receive the second control signal;
an instruction cache to store control information of the second control signal from the second interface; and,
a processing control circuit to receive the control information from the instruction cache, wherein the processing control circuit outputs a first instruction to the first instruction circuit to select the first vector function, and wherein the processing control circuit outputs a second instruction to the second instruction circuit to select the second vector function in response to the control information.

7. The apparatus of claim 1, further comprising:
one or more instruction circuits, coupled to the vector processor, to execute a third plurality of vector functions, wherein a third vector function is selected from the third plurality of vector functions to process a third set of data in response to a third control signal from the vector processor.

8. The apparatus of claim 1, wherein the first plurality of vector functions includes at least one of: filtering the first set of data, cancelling passive intermodulation (PIM) in the first set of data, converting the first set of data from a time domain to a frequency domain and converting the first set of data from an antenna domain to a beam domain, and
wherein the second plurality of vector functions include at least one of a: floating point operation of the second set of data, fixed point operation of the second set of data, summation of the second set of data, subtraction of the second set of data, multiplication of the second set of data and division of the second set of data.

9. The apparatus of claim 1, wherein the apparatus further comprises a processor control circuit to decode and execute change of flow (COF), scalar, load and store instructions.

10. The apparatus of claim 1, wherein the apparatus is included in a base station having an antenna to receive a 5G signal from a user equipment in a cellular network, wherein the first set of data and the second set of data are obtained from the 5G signal.

11. An integrated circuit to process a set of data received from an antenna in a cellular network comprising:
a data memory to store the set of data;
a data organization circuit to organize the set of data from the data memory;
a first instruction circuit to execute a first vector processing function on the set of data from the data organization circuit from a first plurality of functions;
a second instruction circuit to execute a second vector processing function on the set of data from the data organization circuit from a second plurality of functions,
an instruction cache to store control information represented by a first control signal; and,
a processor control circuit to receive the control information from the instruction cache, wherein the processor control circuit outputs a second control signal to the first instruction circuit to select the first vector processing function in response to receipt of the control information from the instruction cache, and
wherein the processor control circuit outputs a third control signal to the second instruction circuit to select the second vector processing function in response to receipt of the control information from the instruction cache,
wherein the first plurality of functions is different than the second plurality of functions.

12. The integrated circuit of claim 11, wherein the first plurality of functions include signal processing vector functions and the second plurality of functions include fixed point or floating point arithmetic vector functions.

13. The integrated circuit of claim 12, wherein the signal processing vector functions include at least one of: filtering the set of data, converting the set of data in a time domain to a frequency domain, cancelling passive intermodulation (PIM) in the set of data, and converting the set of data in an antenna domain to a beam domain.

14. The integrated circuit of claim 11, wherein the first instruction circuit comprises:
a configuration circuit to output a configuration signal in response to the second control signal;
a control logic to output a fourth, fifth, sixth, seventh and eighth control signal in response to the configuration signal;
an operation element array to be configured in response to the fourth control signal;
a register array to store the set of data or a result in response to the fifth control signal;
an interconnection to be configured between the operation elements array and the register array in response to the sixth control signal;
a load circuit to write the set of data to the register array in response to the seventh control signal; and
a store circuit to store the result from the register array in response to the eighth control signal.

15. The integrated circuit of claim 11, wherein the set of data is received from a set of data organization circuits and the first control signal is received from a central processor.

16. The integrated circuit of claim 11, wherein the integrated circuit is included is included in a plurality of integrated circuits coupled to a set of a third instruction circuits, each third instruction circuit to execute a third function on the set of data from a third plurality of functions, and wherein the third plurality of functions includes at least one of channel estimation, Ruu, Ruu inversion and multiple-input and multiple-output (MIMO) processing.

17. A method for operating a vector processor, comprising:
receiving a control signal that indicates a first and second vector function that are to be performed by the vector processor;
configuring a vector instruction circuit in the vector processor to perform the first vector function in response to the control signal;
configuring a big instruction circuit in the vector processor to perform the second vector function in response to the control signal;
organizing a first set of data by a data organization circuit to be processed by the vector instruction circuit;
organizing a second set of data by the data organization circuit to be processed by the big instruction circuit;
performing the first vector function on the first set of data by the vector instruction circuit to provide a first result;
performing the second vector function on the second set of data by the big instruction circuit to provide a second result; and
outputting the first and second results from the vector processor.

18. The method of claim 17, wherein the first vector function is selected from a first plurality of functions that may be performed by the vector instruction circuit that includes at least one of: fixed point or floating point arithmetic vector functions on the first set of data, and
wherein the second vector function is selected from a second plurality of functions that may be performed by the big instruction circuit that includes at least one of filtering the second set of data, converting the second set of data from a time domain to a frequency domain, cancelling passive intermodulation (PIM) in the second set of data and converting the second set of data from an antenna domain to a beam domain.

19. The method of claim 18, wherein performing the second vector function on the second set of data by the big instruction circuit to provide the second result comprises the steps of:
receiving another control signal that indicates the second vector function to be performed by the big instruction circuit;
configuring an operational element array to perform the second vector function in response to the another control signal;
configuring a register array to perform the second vector function in response to the another control signal;
configuring an interconnection between the operational array element and the register array in response to the another control signal;
loading the second set of data to the register array in response to the another control signal; and
storing the second result from the operational element array performing the second vector function on the second set of data in response to the another control signal.

20. The method of claim 19, wherein the first set of data and the second set of data are obtained from a cellular signal received by an antenna from a user equipment in a cellular network, and wherein the vector processor is included in a base station coupled to the antenna in the cellular network.
